(19) United States
(12) Patent Application Publication
(10) Pub. No.: US 2014/0181775 A1
(43) Pub. Date: Jun. 26, 2014

(54) UNIT CAPACITOR MODULE, AUTOMATIC CAPACITOR LAYOUT METHOD THEREOF AND AUTOMATIC CAPACITOR LAYOUT DEVICE THEREOF

(71) Applicant: ALI CORPORATION, Hsinchu (TW)

(72) Inventors: Wei-Hsien Fang, Hsinchu (TW); Ping-Ying Kang, Hsinchu (TW)

(73) Assignee: ALI CORPORATION, Hsinchu (TW)

(21) Appl. No.: 13/798,169

(22) Filed: Mar. 13, 2013

(30) Foreign Application Priority Data
Dec. 20, 2012 (CN) 201210559001.0

(51) Int. Cl. G06F 17/50

(52) U.S. Cl. CPC G06F 17/5072
USPC 716/122

(57) ABSTRACT

A unit capacitor module for automatic capacitor-layout, includes a capacitor unit; at least one first connecting port, coupled to a first side of the capacitor unit; at least one second connecting port, coupled to a second side of the capacitor unit; at least one third connecting port, coupled to a third side of the capacitor unit; and at least one fourth connecting port, coupled to a fourth side of the capacitor unit; wherein the number of first connecting ports equals the number of second connecting ports, and the first connecting port and the second connecting port are symmetrical; and the number of third connecting ports equals the number of fourth connecting ports, and the third connecting port and the fourth connecting port are symmetrical.

### BACKGROUND OF THE INVENTION

1. Field of the Invention

The present invention relates to a unit capacitor module for automatic capacitor layout, an automatic capacitor layout method thereof and an automatic capacitor layout device thereof, and more particularly, to a unit capacitor module for automatic capacitor layout, an automatic capacitor layout method thereof and an automatic capacitor layout device thereof capable of automatically filling blank areas in an integrated circuit.

2. Description of the Prior Art

Since its invention over half a century ago, the integrated circuit has become an essential component for digital electronic products such as computers, notebooks and smart phones. The integrated circuit is one of the most important hardware components in modern society.

When designing an integrated circuit, circuits with different functions are configured into different circuit blocks. When designers want to integrate circuits with different functions, the designers are required to locate all the circuits in a chip area with a constant size. Due to limitations in the manufacturing process, the chip area must be rectangular. Since different circuit blocks have different sizes and the location of each circuit block directly affects the performance of the integrated circuit, the rectangular area of the integrated circuit must have several fragmented blank areas. The designers generally utilize all the metal layers in the manufacturing process to fill the blank areas in order to fit the specifications of the manufacturing process (e.g. the specifications of metal density) and to increase the yield of the integrated circuit. The designers usually fill the fragmented blank area with capacitors, which are formed by all the metal layers in the manufacturing process and are coupled between a power of the integrated circuit and ground, for decreasing noise of the integrated circuit.

Since the fragmented blank areas are too scattered to hard be automatically filled by a computer program, the designers have to manually perform the layout of the capacitors.

### SUMMARY OF THE INVENTION

Therefore, the present invention provides unit capacitor modules, an automatic capacitor layout method thereof and an automatic capacitor layout device for automatically filling blank areas of an integrated circuit.

The present invention discloses a unit capacitor module for automatic capacitor layout. The unit capacitor module comprises a capacitor unit; at least one first connecting port, coupled to a first side of the capacitor unit; at least one second connecting port, coupled to a second side of the capacitor unit; at least one third connecting port, coupled to a third side of the capacitor unit; and at least one fourth connecting port, coupled to a fourth side of the capacitor unit; wherein the number of first connecting ports equals the number of second connecting ports, and the first connecting port and the second connecting port are symmetrical; and the number of third connecting ports equals the number of fourth connecting ports, and the third connecting port and the fourth connecting port are symmetrical.

The present invention further discloses a unit capacitor module for automatic capacitor layout. The unit capacitor module comprises a capacitor unit; at least one first connecting port, coupled to a first side of the capacitor unit; at least one second connecting port, coupled to a second side of the capacitor unit; at least one third connecting port, coupled to a third side of the capacitor unit; and at least one fourth connecting port, coupled to a fourth side of the capacitor unit; wherein the number of first connecting ports equals the number of second connecting ports, and a distance between a first axis of the unit capacitor module and the first connecting port equals a distance between the first axis of the unit capacitor module and the second connecting port; the number of third connecting ports equals the number of fourth connecting ports, and a distance between a second axis of the unit capacitor module and the third connecting port equals a distance between the second axis of the unit capacitor module and the fourth connecting port.

The present invention further discloses a capacitor array for automatic capacitor layout. The capacitor array comprises a plurality of unit capacitor modules, wherein the unit capacitor modules being horizontally coupled among the plurality of unit capacitor modules are horizontally symmetrical and the unit capacitor modules being horizontally coupled among the plurality of unit capacitor modules are vertically symmetrical.

The present invention further discloses an automatic capacitor layout method. The automatic capacitor layout method comprises utilizing a unit capacitor module for generating a first capacitor array, wherein an area of the first capacitor array covers a chip area; acquiring a plurality of circuit areas covered by a plurality of circuit blocks in the chip area according to a layout file; comparing the area of the first capacitor array and the plurality of circuit areas, for removing areas of the first capacitor array overlapping the plurality of circuit areas, to generate a second capacitor array; and generating a final layout file according to the layout file and the second capacitor array.

The present invention further discloses an automatic capacitor layout device. The automatic capacitor layout device comprises a processing unit; and a storage unit, for storing a program code instructing the processing unit to execute the following steps: utilizing a unit capacitor module for generating a first capacitor array, wherein an area of the first capacitor array covers a chip area; acquiring a plurality of circuit areas covered by a plurality of circuit blocks in the chip area according to a layout file; comparing the area of the first capacitor array and the plurality of circuit areas, for removing areas of the first capacitor array overlapping the plurality of circuit areas to generate a second capacitor array; and generating a final layout file according to the layout file and the second capacitor array.

The present invention further discloses an automatic capacitor layout method. The automatic capacitor layout method comprises acquiring a chip area and a plurality of circuit areas covered by a plurality of circuit blocks in the chip area according to a layout file; comparing the chip area and the plurality of circuit areas, for removing areas in the chip area overlapping the plurality of circuit areas to generate a capacitor area; utilizing a unit capacitor module for generating a capacitor array to fill the capacitor area, wherein an area of the capacitor array is smaller than or equal to the capacitor area; and generating a final layout file according to the layout file and the capacitor array.

The present invention further discloses an automatic capacitor layout device. The automatic capacitor layout device comprises a processing unit; and a storage unit, for storing a program code instructing the processing unit to execute the following steps: acquiring a chip area and a plurality of circuit areas covered by a plurality of circuit blocks in the chip area according to a layout file; comparing the chip area and the plurality of circuit areas, for removing areas in the chip area overlapping the plurality of circuit areas to generate a capacitor area; utilizing a unit capacitor module for generating a capacitor array to fill the capacitor area, wherein an area of the capacitor array is smaller than or equal to the capacitor area; and generating a final layout file according to the layout file and the capacitor array.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a unit capacitor module according to an embodiment of the present invention.

FIG. 2 is a schematic diagram of a capacitor array according to an embodiment of the present invention.

FIG. 3 is a schematic diagram of an automatic capacitor layout device according to an embodiment of the present invention.

FIG. 4 is a flow chart of an automatic capacitor layout method according to an embodiment of the present invention.

FIG. 5A and FIG. 5B are schematic diagrams of examples of the automatic capacitor layout method shown in FIG. 4.

FIG. 6 is a schematic diagram of an example of the unit capacitor module shown in FIG. 1.

FIGS. 7A-7C are schematic diagrams of other examples of the unit capacitor module shown in FIG. 1.

FIG. 8 is a schematic diagram of a capacitor array according to another embodiment of the present invention.

### DETAILED DESCRIPTION

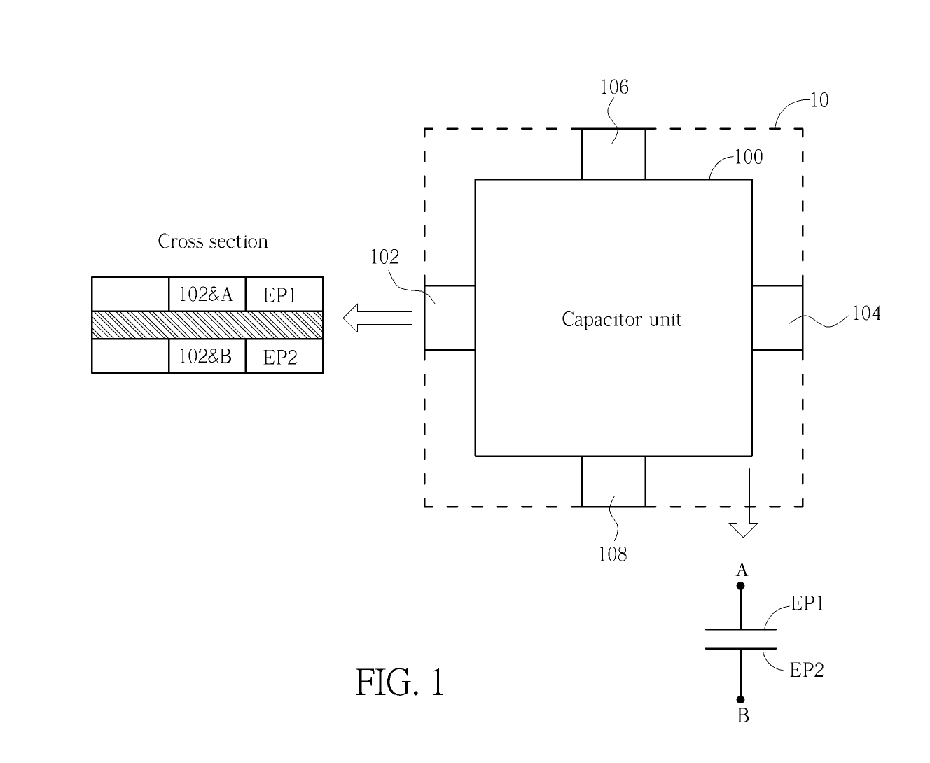

Please refer to FIG. 1, which is a schematic diagram of a unit capacitor module 10 according to an embodiment of the present invention. The unit capacitor module 10 can be utilized for automatically filling blank areas of an integrated circuit. As shown in FIG. 1, the unit capacitor module 10 comprises a capacitor unit 100 and connecting ports 102, 104, 106, 108. The capacitor unit 100 is a capacitor which can be realized by various methods. For example, the capacitor unit 100 can be a finer-type capacitor or a metal-insulator-metal capacitor, but is not limited herein. The connecting port 102 is symmetric with respect to the connecting port 104 and the connecting port 106 is symmetric with respect to the connecting port 108. If a designer utilizes the unit capacitor module 10 to realize a capacitor array, the unit capacitor modules 10 in the capacitor array are automatically connected to each other through the connecting ports 102, 104, 106, 110 surrounding the unit capacitor modules 10. The designer does not have to manually connect the unit capacitor modules 10 in the capacitor array.

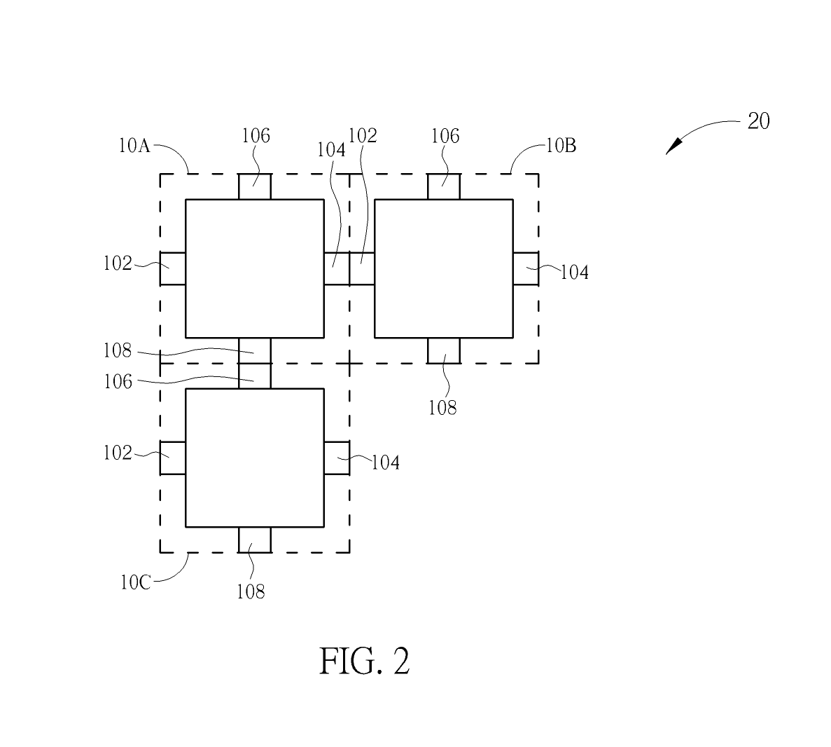

Please refer to FIG. 1 and FIG. 2, wherein FIG. 2 is a schematic diagram of a capacitor array 20 according to an embodiment of the present invention. As shown in FIG. 1, the capacitor unit 100 can be represented by a unit capacitor UC, wherein the unit capacitor US is realized by electrode plates EP1, EP2. The electrode plate EP1 is coupled to a node A and the electrode plate EP2 is coupled to a node B. The connecting port 102 provides transmission paths to the node A and the node B, separately. Similarly, the connecting ports 104, 106, 108 also separately provide transmission paths to the node A and the node B. In this embodiment, the connecting port 102 is coupled to the middle of the left side of the capacitor unit 100 and the connecting port 104 is coupled to the middle of the right side of the capacitor unit 100. The connecting port 104 of a unit capacitor module 10A of the capacitor array 20 therefore couples to the connecting port 102 of a unit capacitor module 10B of the capacitor array 20. The unit capacitors UC (i.e. the capacitor units 100) of the horizontally coupled unit capacitor modules 10A, 10B are in parallel. Please note that, as long as the connecting port 102 is symmetric with respect to the connecting port 104 for allowing the horizontally coupled unit capacitor modules 10 in the capacitor array 20 to be automatically connected, the locations of the connecting ports 102, 104 are not limited to the connecting methods shown in FIG. 1.

The connecting port 106 is coupled to the middle of the top side of the capacitor unit 100 and the connecting port 108 is coupled to the middle of the bottom side of the capacitor unit 100. The connecting port 108 of the unit capacitor module 10A of the capacitor array 20 therefore connects to the connecting port 106 of a unit capacitor module 10C. The unit capacitors UC (i.e. the capacitor units 100) of the unit capacitor modules which are vertically coupled (i.e. the unit capacitor modules 10A, 10C) are in parallel. Noticeably, as long as the connecting port 106 is symmetric with respect to the connecting port 108 for allowing the unit capacitor modules 10 vertically coupled in the capacitor array to be automatically connected, the locations of the connecting ports 106, 108 are not limited to the connecting methods shown in FIG. 1. As a result, all the unit capacitor modules 10 in the capacitor array 20 realized by the unit capacitor module 10 are automatically coupled to each other. The designer does not have to manually connect unit capacitor modules 10 in the capacitor array 20.

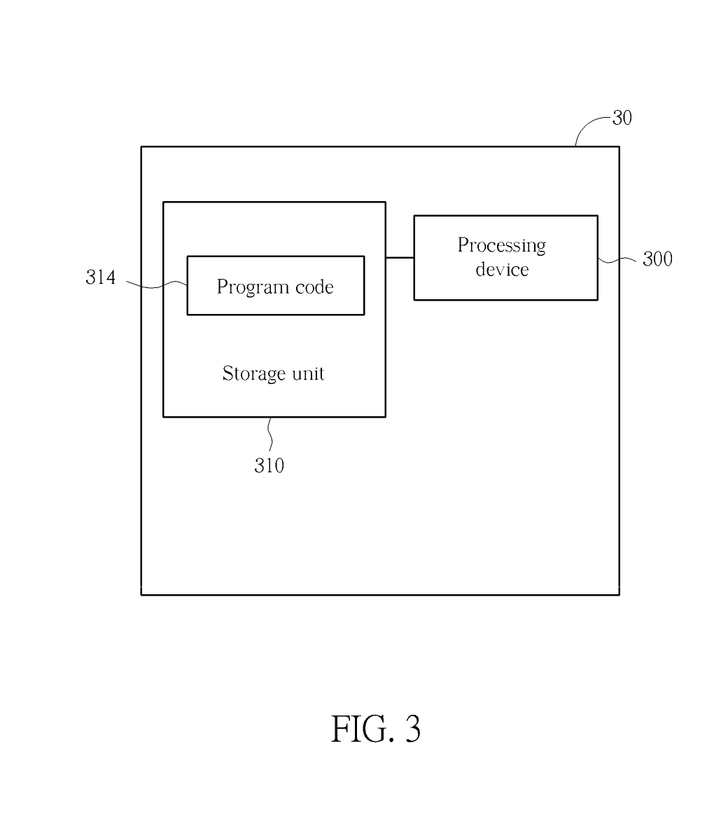

After acquiring the unit capacitor module 10, the designer can automatically fill blank areas (areas which are not covered by circuit blocks among a chip area) through an automatic capacitor layout device. Please refer to FIG. 3, which is a schematic diagram of an automatic capacitor layout device 30 according to an embodiment of the present invention. The automatic capacitor layout device 30 comprises a processing unit 300 and a storage unit 310. The storage unit 310 is utilized for storing a program code 314, to allow the processing unit 300 to perform the program code 314.

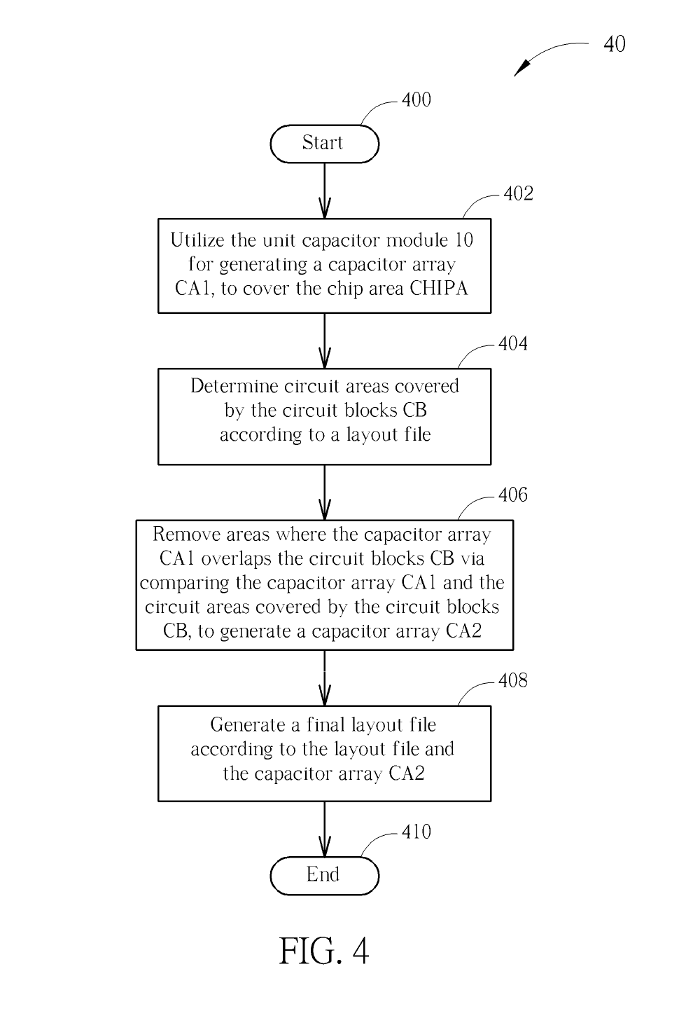

Please refer to FIG. 4, which is a flow chart of an automatic capacitor layout method 40 according to an embodiment of the present invention. The automatic capacitor layout method 40 can be utilized for automatically filling blank areas not covered by circuit blocks CB among a chip area CHIPA and can be compiled to the program code 314 shown in FIG. 3. The automatic layout method 40 comprises:

Step 400: Start.

Step 402: Utilize the unit capacitor module 10 for generating a capacitor array CA1, to cover the chip area CHIPA.

Step 404: Determine circuit areas covered by the circuit blocks CB according to a layout file.

Step 406: Remove areas where the capacitor array CA1 overlaps the circuit blocks CB via comparing the capacitor array CA1 and the circuit areas covered by the circuit blocks CB, to generate a capacitor array CA2.

Step 408: Generate a final layout file according to the layout file and the capacitor array CA2.

Step 410: End.

According to the automatic capacitor layout method 40, the automatic capacitor layout device 30 can automatically fill the areas not covered by the circuit blocks CB among the chip area CHIPA. The designer does not have to manually configure the layout of the chip area CHIPA.

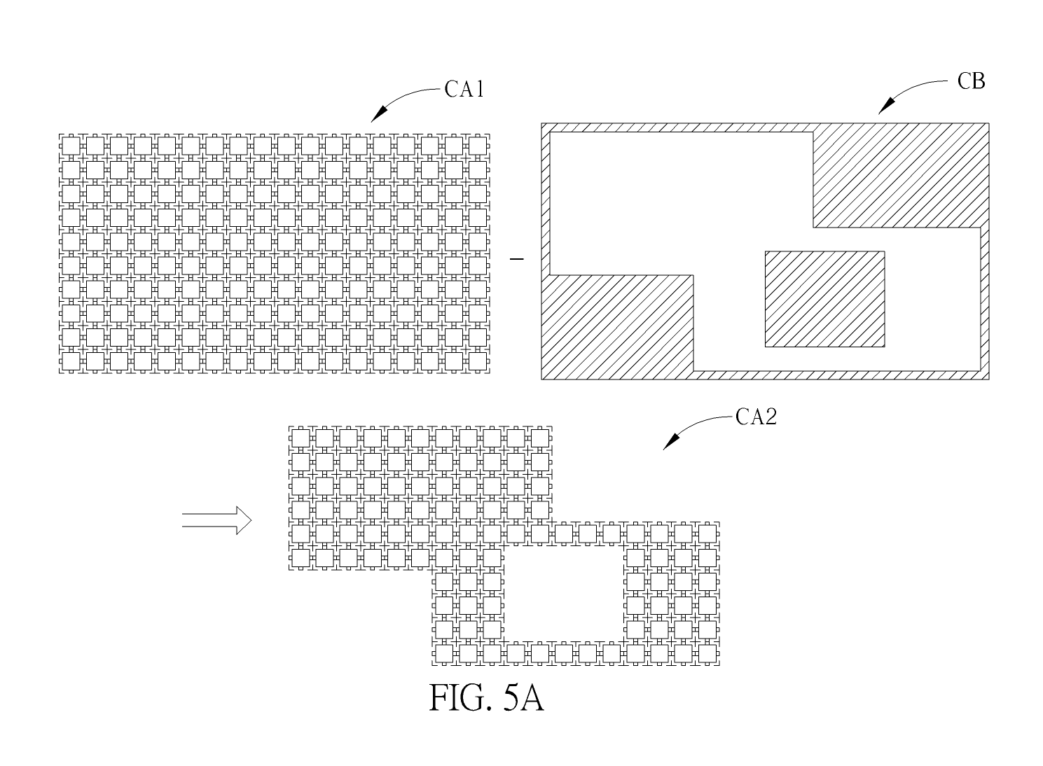

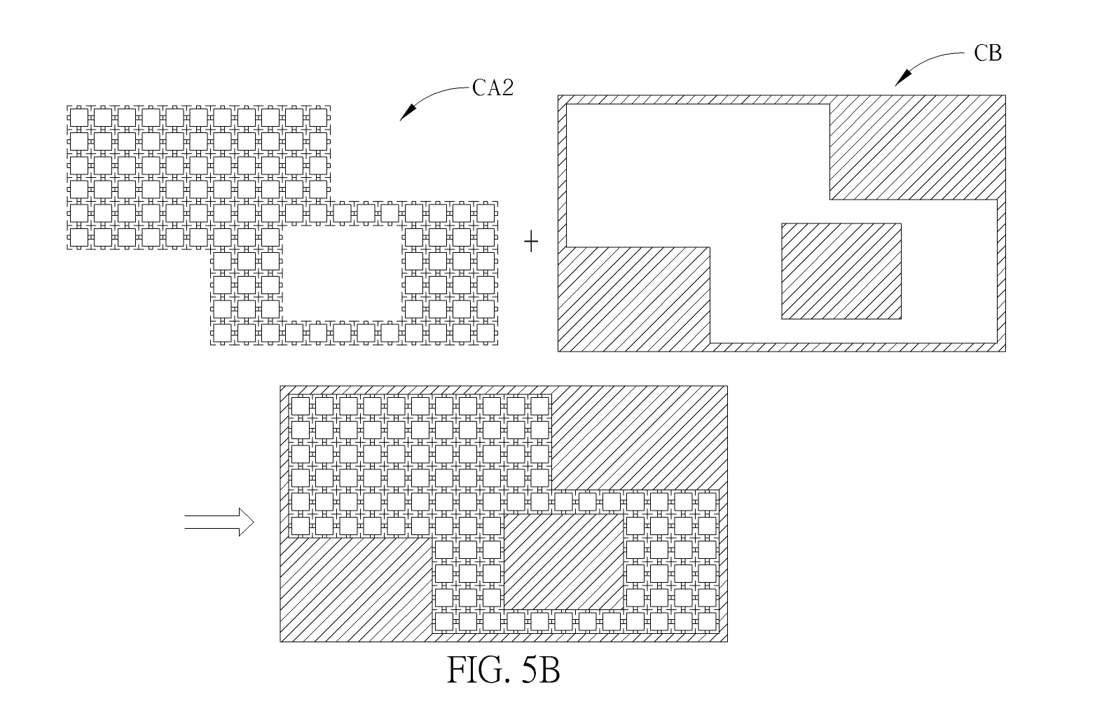

Please refer to FIG. 5A and FIG. 5B, which are examples of the automatic capacitor layout method 40 shown in FIG. 4. As shown in FIG. 5A, the automatic capacitor layout device 30 first utilizes the unit capacitor module 10 to generate the capacitor array CA1, the area of which equals the chip area CHIPA (Step 402). Next, the automatic capacitor layout device 30 acquires the positions of the circuit areas covered by the circuit blocks CB via reading the layout file (step 404). The automatic capacitor layout device 30 accordingly removes areas where the capacitor array CA1 overlaps the circuit areas covered by the circuit blocks CB, to generate the capacitor array CA2 (Step 406). Based on the character of the unit capacitor module 10, the capacitor array CA2 is equivalent to a capacitor formed by all the unit capacitor modules 10 of the capacitor array CA2. The capacitor array CA2 is coupled between the power supply of the circuit blocks CB and ground for reducing the noise in the circuit blocks CB. Please refer to FIG. 5B; the automatic capacitor layout device 30 finally combines the circuit blocks CB and the capacitor array CA2 according to the layout file and the capacitor array CA2, to generate the final layout file (Step 408). Noticeably, if the area of the unit capacitor module 10 is sufficiently small, all the blank areas in the final layout file can be filled by the unit capacitor modules 10. The integrated circuit realized according to the final layout file therefore fits the specifications of the manufacturing process (e.g. the specifications of metal density) and the yield of the integrated circuit increases.

The main spirit of the present invention is automatically connecting the unit capacitor modules in the capacitor array via the connecting ports surrounding each unit capacitor module. The designer can therefore use the unit capacitor module to automatically fill blank areas in the integrated circuit, instead of manually performing capacitor layout. According to different applications, those skilled in the art may accordingly observe appropriate alternations and modifications. For example, the automatic capacitor layout method 40 shown in FIG. 4 can be modified into the following steps: acquire a chip area and a plurality of circuit areas covered by a plurality of circuit blocks in the chip area according to a layout file; remove areas where the chip area overlaps the plurality of circuit area via comparing the chip area and the plurality of circuit areas, for generating a capacitor area; utilize a unit capacitor to automatically fill the capacitor area, for generating a first capacitor array, wherein the area of the first capacitor array is smaller than or equal to the capacitor area; and generate a final layout file according to the layout file and the first capacitor array.

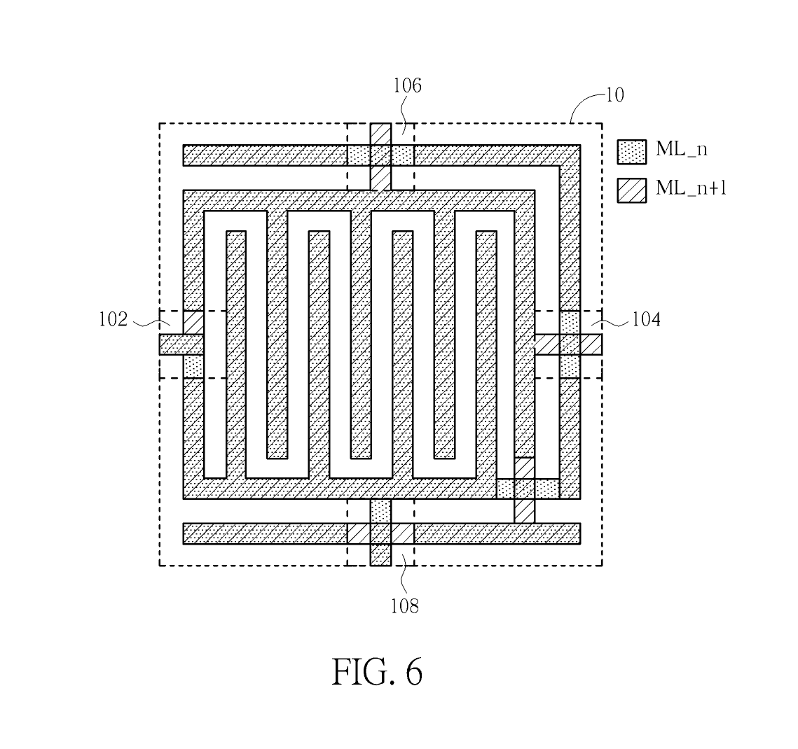

Please refer to FIG. 6, which is a schematic diagram of an example of the unit capacitor module 10 shown in FIG. 1. As shown in FIG. 6, the capacitor unit 100 is a finger type capacitor realized by a metal layer ML_n and a metal layer ML n+1. The connecting port 102 is transmission paths on the left side of the capacitor unit 100 provided by the metal layer ML_n and the metal layer ML_n+1. Similarly, the connecting ports 104, 106, 108 are transmission paths on the right side, the top side and the bottom side of the capacitor unit 100, respectively, provided by the metal layer ML_n and the metal layer ML_n+1.

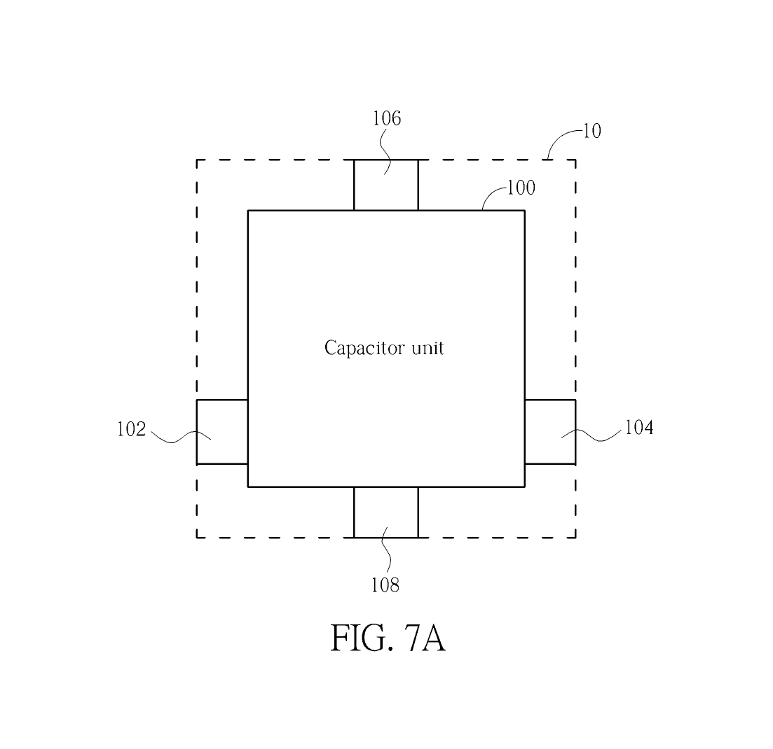

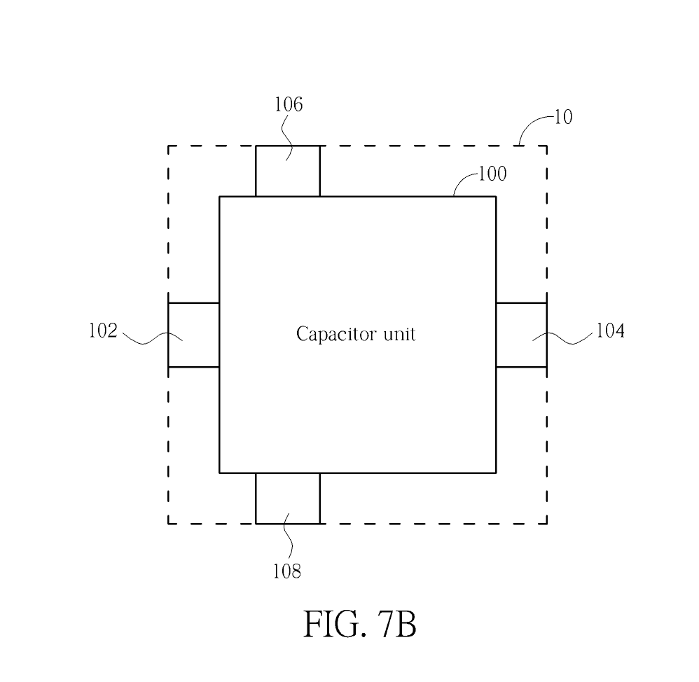

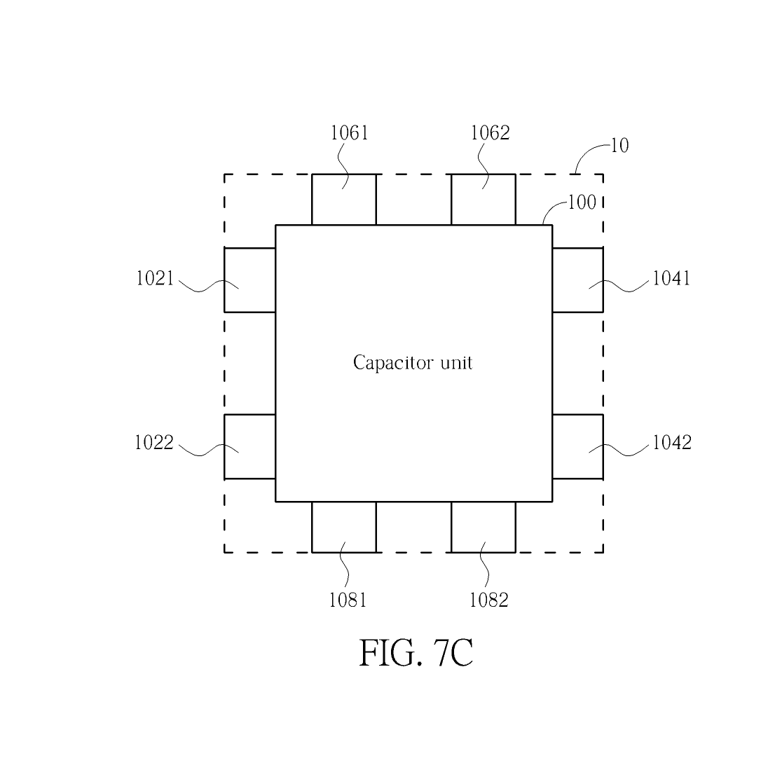

As long as the connecting port 102 is symmetric with respect to the connecting port 104 and the connecting port 106 is symmetric with respect to the connecting port 108, the locations of the connecting ports 102, 104, 106, 108 are not limited to those shown in FIG. 1. Please refer to FIGS. 7A-7C, which are schematic diagrams of examples of the unit capacitor module 10 shown in FIG. 1. In FIG. 7A, the connecting ports 102, 104 are jointly shifted down, and are separately coupled to the bottom of the left side and the bottom of the right side of the capacitor unit 100. In FIG. 7B, the connecting ports 106, 108 are jointly shifted left and are coupled to the left of the top side and the left of the bottom side of the capacitor unit 100.

Furthermore, each side of the capacitor unit 100 may comprise multiple connecting ports. Please refer to FIG. 7C, the unit capacitor module 10 comprises connecting ports 1021, 1022, 1041, 1042, 1061, 1062, 1081, 1082. The connecting port 1021 is symmetric with respect to the connecting port 1041. The connecting port 1022 is symmetric with respect to the connecting port 1042, and so on. As a result, the unit capacitor module 10 shown in FIG. 7C still retains the original characteristic feature.

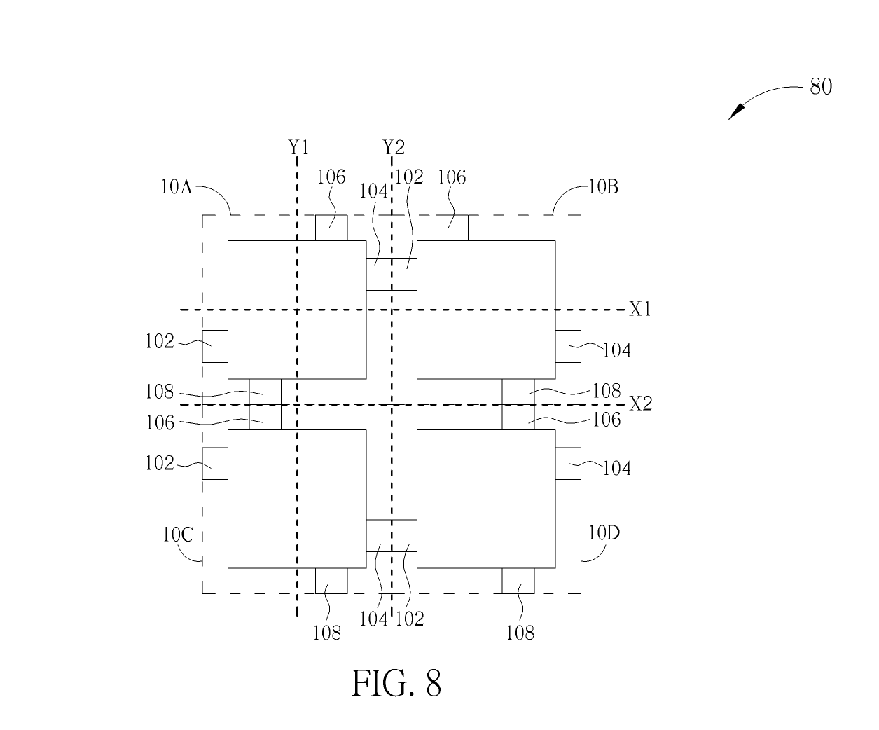

The unit capacitor module 10 also can be automatically connected under the condition that the connecting port 102 is asymmetric with respect to the connecting port 104 and the connecting port 106 is asymmetric with respect to the connecting port 106. In the capacitor array realized by the unit capacitor modules 10 with asymmetric connecting ports, the connecting ports 102, 104 of the adjacent unit capacitor modules 10 are vertically reversed and the connecting ports 106, 108 of the adjacent unit capacitor modules 10 are horizontally reversed. Please refer to FIG. 8, which is a schematic diagram of a capacitor array 80 according to an embodiment of the present invention. As shown in FIG. 8, the connecting port 102 of each unit capacitor module in the capacitor array 80 is asymmetric with respect to the connecting port 104 of each unit capacitor module in the capacitor array 80 and the connecting port 106 of each unit capacitor module in the capacitor array 80 is asymmetric with respect to the connecting port 108 of each unit capacitor module in the capacitor array 80. The locations of the connecting ports 102, 104 of the unit capacitor modules 10B, 10C are derived from reversing the connecting ports 102, 104 of the unit capacitor module 10A along an axis X1. The axis X1 is the centerline of the vertical direction of the unit capacitor module 10A. The locations of the connecting ports 106, 108 of the unit capacitor modules 10B, 10C are derived from reversing the connecting ports 106, 108 of the unit capacitor module 10A along an axis Y1. The axis Y1 is the centerline of the horizontal direction of the unit capacitor module 10A. As a result, the unit capacitor modules 10A-10D are automatically connected without manual layout.

In another aspect, since components of the connecting ports 102-108 are the same, the horizontally adjacent unit capacitor modules in the capacitor array 80 (i.e. the unit capacitor module 10A and the unit capacitor module 10B or the unit capacitor module 10C and the unit capacitor module 10D) can be considered as horizontally symmetric along an axis Y2. The vertically adjacent unit capacitor modules in the capacitor array 80 (i.e. the unit capacitor module 10A and the unit capacitor module 10C or the unit capacitor module 10B and the unit capacitor module 10D) can be considered as vertically symmetric along an axis X2. According to the building rules of the capacitor array 80, the automatic capacitor layout device 30 can use the unit capacitor modules with asymmetric connecting ports to automatically fill the blank areas which are not covered by the circuit blocks.

To sum up, when utilizing the unit capacitor modules of the above embodiments to realize a capacitor array, the units capacitor modules are automatically connected via the surrounding connecting ports of each unit capacitor module. The designer can therefore use the unit capacitor module to automatically fill the blank areas in the integrated circuit without manual layout.

Those skilled in the art will readily observe that numerous modifications and alterations of the device and method may be made while retaining the teachings of the invention. Accordingly, the above disclosure should be construed as limited only by the metes and bounds of the appended claims.

1. A unit capacitor module for automatic capacitor layout, comprising:
a capacitor unit;
at least one first connecting port, coupled to a first side of the capacitor unit;
at least one second connecting port, coupled to a second side of the capacitor unit;
at least one third connecting port, coupled to a third side of the capacitor unit; and
at least one fourth connecting port, coupled to a fourth side of the capacitor unit;
wherein the number of first connecting ports equals the number of second connecting ports, and the first connecting port and the second connecting port are symmetrical; and the number of third connecting ports equals the number of fourth connecting ports, and the third connecting port and the fourth connecting port are symmetrical.

2. The unit capacitor module of claim 1, wherein one of the first connecting ports is coupled to a middle of the first side and one of the second connecting ports is coupled to a middle of the second side.

3. The unit capacitor module of claim 1, wherein one of the third connecting ports is coupled to a middle of the third side and one of the fourth connecting ports is coupled to a middle of the fourth side.

4. An automatic capacitor layout method, comprising:
utilizing a unit capacitor module for generating a first capacitor array, wherein an area of the first capacitor array covers a chip area;
acquiring a plurality of circuit areas covered by a plurality of circuit blocks in the chip area according to a layout file;
comparing the area of the first capacitor array and the plurality of circuit areas, for removing areas of the first capacitor array overlapping the plurality of circuit areas, to generate a second capacitor array; and
generating a final layout file according to the layout file and the second capacitor array.

5. A unit capacitor module for automatic capacitor layout, comprising:
a capacitor unit;
at least one first connecting port, coupled to a first side of the capacitor unit;
at least one second connecting port, coupled to a second side of the capacitor unit;
at least one third connecting port, coupled to a third side of the capacitor unit; and
at least one fourth connecting port, coupled to a fourth side of the capacitor unit;
wherein the number of first connecting ports equals the number of second connecting ports, and a distance between a first axis of the unit capacitor module and the first connecting port equals a distance between the first axis of the unit capacitor module and the second connecting port; the number of third connecting ports equals the number of fourth connecting ports, and a distance between a second axis of the unit capacitor module and the third connecting port equals a distance between the second axis of the unit capacitor module and the fourth connecting port.

6. An automatic capacitor layout device, comprising:
a processing unit; and
a storage unit, for storing a program code instructing the processing unit to execute the following steps:
utilizing a unit capacitor module for generating a first capacitor array, wherein an area of the first capacitor array covers a chip area;
acquiring a plurality of circuit areas covered by a plurality of circuit blocks in the chip area according to a layout file;
comparing the area of the first capacitor array and the plurality of circuit areas, for removing areas of the first capacitor array overlapping the plurality of circuit areas to generate a second capacitor array; and
generating a final layout file according to the layout file and the second capacitor array.

7. A capacitor array for automatic capacitor layout, comprising:
a plurality of unit capacitor modules, wherein the unit capacitor modules being horizontally coupled among the plurality of unit capacitor modules are horizontally symmetrical and the unit capacitor modules being vertically coupled among the plurality of unit capacitor modules are vertically symmetrical.

8. An automatic capacitor layout method, comprising:
acquiring a chip area and a plurality of circuit areas covered by a plurality of circuit blocks in the chip area according to a layout file;
comparing the chip area and the plurality of circuit areas, for removing areas in the chip area overlapping the plurality of circuit areas to generate a capacitor area;
utilizing a unit capacitor module for generating a capacitor array to fill the capacitor area, wherein an area of the capacitor array is smaller than or equal to the capacitor area; and
generating a final layout file according to the layout file and the capacitor array.

9. An automatic capacitor layout device, comprising:
a processing unit; and
a storage unit, for storing a program code instructing the processing unit to execute the following steps:
acquiring a chip area and a plurality of circuit areas covered by a plurality of circuit blocks in the chip area according to a layout file;
comparing the chip area and the plurality of circuit areas, for removing areas in the chip area overlapping the plurality of circuit areas to generate a capacitor area;
utilizing a unit capacitor module for generating a capacitor array to fill the capacitor area, wherein an area of the capacitor array is smaller than or equal to the capacitor area; and
generating a final layout file according to the layout file and the capacitor array.
